(19) United States
(12) Patent Application Publication
(10) Pub. No.: US 2026/0274088 A1
(43) Pub. Date: Sep. 17, 2026

(54) VEHICLE BATTERY MODULE COMPRISING POWER CONVERSION DEVICE, AND VEHICLE BATTERY SYSTEM FORMED ON BASIS OF PLURALITY OF VEHICLE BATTERY MODULES

(71) Applicants: Hyundai Motor Company, Seoul (KR); Kia Corporation, Seoul (KR)

(72) Inventors: Sung-Min HONG, Hwaseong-si Gyeonggi-do (KR); Yong-Gyu LEE, Hwaseong-si Gyeonggi-do (KR)

(73) Assignees: Hyundai Motor Company, Seoul (KR); Kia Corporation, Seoul (KR)

(21) Appl. No.: 19/472,851

(22) PCT Filed: Aug. 9, 2024
(86) PCT No.: PCT/KR2024/011925

§ 371 Date: Oct. 6, 2025

(30) Foreign Application Priority Data
Aug. 9, 2023 (KR) 10-2023-0104386

(51) Int. Cl. B60L 50/64; H01M 10/42; H01M 50/204; H01M 50/249; H01M 50/51; H02M 1/00

(52) U.S. Cl. CPC B60L 50/64; H01M 10/4264; H01M 50/204; H01M 50/249; H01M 50/51; H02M 1/008; B60L 2210/12; B60L 2210/42; H01M 2220/20

(57) ABSTRACT

The present invention relates to a vehicle battery module comprising a power conversion device, and a three-phase vehicle battery system formed on the basis of a plurality of vehicle battery modules. The vehicle battery module comprises a battery, a DC/DC converter, and a three-phase alternating current unit for outputting a three-phase alternating current module voltage. The three-phase vehicle battery system comprises: a direct current system output terminal which includes a plurality of vehicle battery modules, and which is formed by connecting, in parallel, the direct current module output terminals included in each of the plurality of vehicle battery modules; and a three-phase alternating current system output terminal formed by serially connecting, by phase, the three-phase alternating current module output terminals included in each of the plurality of vehicle battery modules.

### TECHNICAL FIELD

The present disclosure relates to a vehicle battery module including a power conversion device, and a vehicle battery system configured based on a plurality of vehicle battery modules.

### BACKGROUND ART

Nowadays, with increasing interest in issues, such as energy efficiency, environmental pollution, and fossil fuel depletion, eco-friendly vehicles that may practically replace internal combustion engine vehicles have been actively developed.

Eco-friendly vehicles include battery electric vehicles (BEVs) using batteries as a power source, fuel cell electric vehicles (FCEVs) using fuel cells as a primary power source, and hybrid electric vehicles (HEVs) using both an engine and a motor as driving devices.

These eco-friendly vehicles may be broadly defined as electric vehicles (xEVs) and have in common the characteristics of being motor-driven vehicles and electrified vehicles that run by driving a motor with electricity from a high-voltage power source, such as a battery or fuel cell.

Electric vehicles are equipped with high-voltage batteries supplying power to the motor, and the high-voltage batteries supply power to power electronics components within the vehicles, such as motors, while being charged with and discharged of electricity during vehicle operation. Also, since the size and type of voltages required for each type of power electronics component are different, various types of power conversion devices are required to convert an output voltage of high-voltage batteries. Here, the power conversion device has to convert the high voltage output from high voltage batteries, so a high voltage power conversion device is required, and because the high voltage batteries are expensive, the production cost may increase.

### DISCLOSURE OF INVENTION

### Technical Problem

An aspect of the present disclosure is to enable the use of power conversion devices operable at low voltage by allowing a conventional electric vehicle driving system operating at high voltage to be configured with a series/parallel combination of a plurality of battery modules operating at low voltage.

Another aspect of the present disclosure is to configure a battery system by connecting standardized battery modules in series or in parallel, thereby outputting voltages of various magnitudes depending on the intended purpose and meeting the diverse specifications required by each vehicle model.

The objects of the present disclosure are not limited to the aforementioned tasks, and other tasks not mentioned will be clearly understood by those skilled in the art from the following description.

### Solution to Problem

In order to achieve the above-mentioned objects, the present disclosure provides a vehicle battery module and a three-phase vehicle battery system configured based on the vehicle battery module.

According to an aspect of the present disclosure, a vehicle battery module includes a battery outputting a battery voltage, a first DC/DC converter converting the battery voltage into a first direct current (DC) module voltage lower than the battery voltage and outputs the first DC module voltage, and a three-phase alternating current (AC) unit converting the battery voltage into a three-phase AC module voltage and outputting the three-phase AC module voltage, wherein the three-phase AC unit includes an inverter converting the battery voltage into an AC voltage and a transformer converting an output of the inverter into an AC module voltage corresponding to one phase of the three-phase AC module voltage.

According to an aspect of the present disclosure, a three-phase vehicle battery system includes a plurality of vehicle battery modules including a first DC module output terminal outputting a first DC module voltage that is lower than an internal battery voltage from the internal battery voltage and a three-phase AC module output terminal outputting a three-phase AC module voltage having the same phase difference, a first DC system output terminal configured as the first DC module output terminals respectively included in the plurality of vehicle battery modules are connected in parallel, and a three-phase AC system output terminal configured as the three-phase AC module output terminals respectively included in the plurality of vehicle battery modules are connected in series by phases.

### Advantageous Effects of Invention

According to an embodiment of the present disclosure, manufacturing costs may be reduced by applying a power conversion device operable at low voltage using standardized battery module operable at low voltage.

Furthermore, even if the required voltage or specifications are different for each vehicle model, standardized battery modules may be combined in series or in parallel to meet various specifications, and since mass production is possible, production costs may be reduced.

Furthermore, according to an embodiment of the present disclosure, since a battery module system may be configured by connecting standardized battery modules in series or in parallel, space usage efficiency may be increased, thereby reducing overall volume, and in the event of a failure, each battery module may be replaced, thereby facilitating repairs, and balance control for each battery module may be implemented, thereby increasing overall energy efficiency.

### BRIEF DESCRIPTION OF DRAWINGS

FIG. 1 illustrates an electric vehicle driving system including a general high-voltage battery pack.

FIG. 2 is a block diagram illustrating a battery module and a three-phase battery system according to an embodiment of the present disclosure.

FIGS. 3 and 4 illustrate a battery module according to an embodiment of the present disclosure.

FIG. 5 is a diagram illustrating a connection structure between a plurality of battery modules according to an embodiment of the present disclosure.

FIG. 6 illustrates a three-phase battery system according to an embodiment of the present disclosure.

FIG. 7 is a diagram illustrating an inverter structure according to an embodiment of the present disclosure.

### MODE FOR THE INVENTION

Hereinafter, embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

In addition, a “module voltage” described below may refer to a voltage output from a battery module, and a “system voltage” may refer to a voltage output from a battery system configured based on the battery module.

The battery module described below may include a vehicle battery module, and the battery system may include a three-phase vehicle battery system.

The present disclosure may be used not only in vehicles but also in various devices to which battery modules and battery systems are applicable.

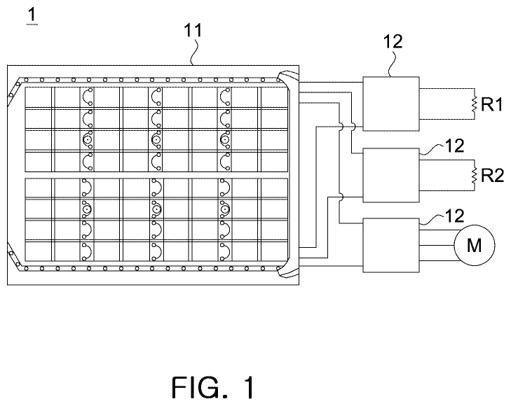

FIG. 1 illustrates an electric vehicle driving system including a general high-voltage battery pack.

Referring to FIG. 1, the electric vehicle driving system (1) may include a general high-voltage battery pack (11) and various power conversion devices (12).

Here, the general high-voltage battery pack (11) is configured with a series/parallel combination of a plurality of battery cells and may not include a separate power conversion device. The general high-voltage battery pack (11) may output a single high voltage (e.g., 480 V to 806.4 V). The power conversion device (12) may be provided in a separate space, separate from the high-voltage battery pack (11), and the high-voltage battery pack (11) and the power conversion device (12) may be connected via a high-voltage cable.

Meanwhile, electric vehicles have electrical loads with various functions, and since each electrical load requires a different voltage level and type, a variety of power conversion devices (12) are required. However, the electric vehicle driving system (1) including the general high-voltage battery pack (11) is based on a single high voltage, the electric vehicle driving system (1) has to use the power conversion device (12) for high voltages.

More specifically, the electric vehicle driving system (1) converts a high voltage output from the general high-voltage battery pack (11) into a low DC voltage to provide a driving voltage to a low-voltage load (R1) or to charge a low-voltage battery. At this time, energy loss may occur during the process of converting power from high voltage to low voltage, reducing efficiency. Furthermore, since the voltage has to be significantly lowered, a separate transformer may be required.

The electric vehicle driving system (1) may convert the voltage output from the general high-voltage battery pack (11) to provide a driving voltage to a high-voltage load (R2) and generate a high-voltage three-phase AC power source to provide a driving voltage to a motor (M). Inverters operating at high voltage generally use Sic power semiconductors for high-voltage switching. However, Sic power semiconductors have low yields, as compared to high demand, so that the SiC power semiconductors may be difficult to be smoothly supplied, and high price thereof may increase production costs.

Furthermore, in the electric vehicle driving system (1) has a structure in which the high-voltage battery pack (11) and power conversion devices are separated, each occupying separate space, and since high-voltage cables have to be used to connect them, which may be bulky.

Furthermore, the electric vehicle driving system (1) may generate significant heat due to the high voltage output of the high-voltage battery pack (11) and require a water cooling system to control the heat generation, resulting in a bulky and heavy system.

Also, according to the electric vehicle driving system (1), since the specifications are different depending on the vehicle type, the battery system has to be individually designed according to the specifications of the vehicle type, which may complicate the process and increase production costs.

The battery system according to an embodiment of the present disclosure described below may be configured with a series/parallel combination of a plurality of battery modules, and each battery module may include a power conversion device operating at low voltage.

In other words, the battery system according to an embodiment of the present disclosure is configured based on battery modules, and each battery module includes a power conversion device operating at low voltage. Therefore, the battery system may not only store/release electrical energy but also perform power conversion in the battery module. Therefore, the battery module according to an embodiment of the present disclosure may convert direct current (DC) to alternating current (AC) or convert the magnitude of battery power and output the same as needed.

In addition, the outputs of each battery module may be connected in series to form a high-voltage output or in parallel to form a large-current output, and the voltage of each battery module may be monitored for balancing control.

Hereinafter, a battery module and a battery system including the same according to an embodiment of the present disclosure will be described in more detail.

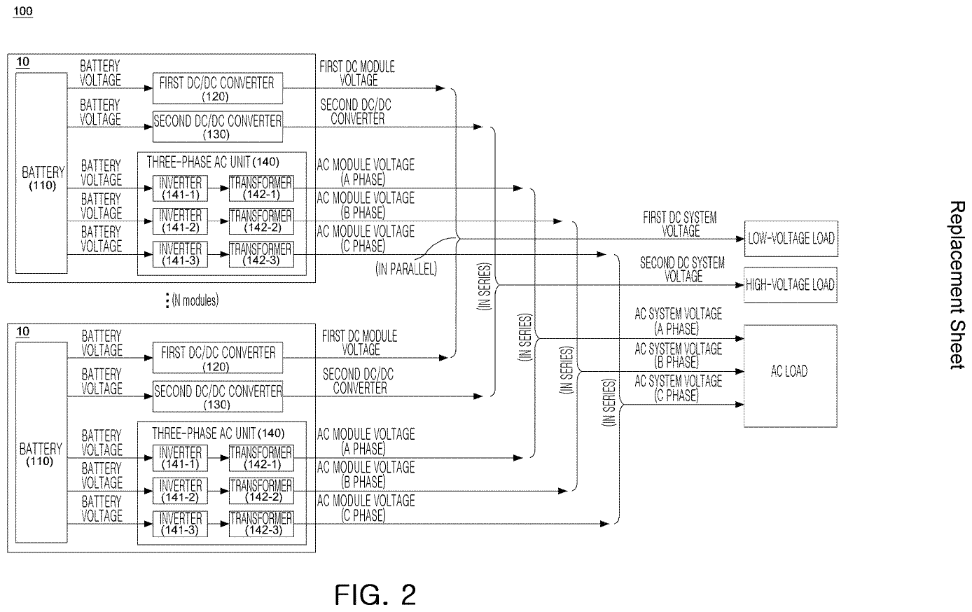

FIG. 2 is a block diagram illustrating a battery module and a three-phase battery system according to an embodiment of the present disclosure.

Referring to FIG. 2, a battery module (10) according to an embodiment of the present disclosure may include a battery (110), a first DC/DC converter (120), a second DC/DC converter (130), and a three-phase AC unit (140).

The first DC/DC converter (120) may convert a battery voltage into a first DC module voltage that is lower than the battery voltage and output the same. The second DC/DC converter (130) may convert the battery voltage into a second DC module voltage that is higher than the first DC module voltage and output the same.

Furthermore, the three-phase AC unit (140) may convert the battery voltage into a three-phase AC module voltage comprising an A-phase AC module voltage, a B-phase AC module voltage, and a C-phase AC module voltage and output the same.

The three-phase AC unit (140) may include an inverter (141) converting the battery voltage into AC voltage and a transformer (142) converting the AC voltage output from an output terminal of the inverter into an AC module voltage corresponding to one phase of the three-phase AC module voltage.

Also, the first DC system voltage may be configured by connecting a plurality of first DC module voltages in parallel, and the first DC system voltage and the first DC module voltage may have the same magnitude. The first DC system voltage may be a supply voltage for a low-voltage load.

The second DC system voltage may be configured by connecting a plurality of second DC module voltages in series. In a battery system including N battery modules, the second DC system voltage may be N times the second DC module voltage. The second DC system voltage may be a supply voltage for a high-voltage load.

In addition, the three-phase AC system voltage may be configured by connecting a plurality of three-phase AC module voltages in series for each phase, and when N three-phase AC module voltages are connected in series, the three-phase AC system voltage may be configured as N times the three-phase AC module voltage. Furthermore, the three-phase AC system voltage may be a supply voltage for a three-phase AC load and may include AC system voltages having A, B, or C phase. For Example, the A, B, or C phase AC system voltages may be configured as AC voltages having the same magnitude and a phase difference of 120 degrees.

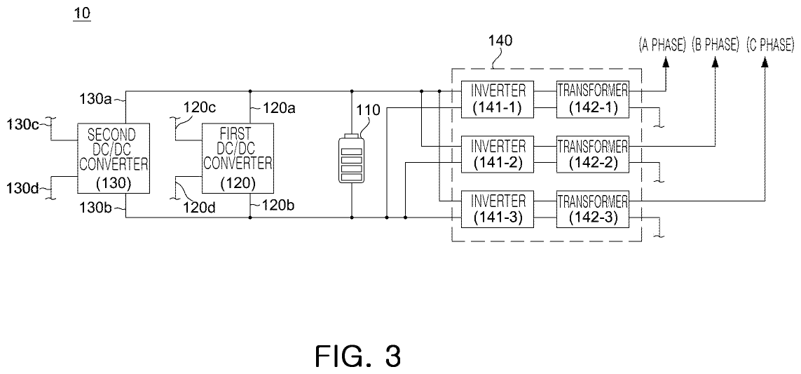

FIG. 3 illustrates a battery module according to an embodiment of the present disclosure.

Referring to FIG. 3, the battery module (10) according to an embodiment of the present disclosure may include a battery (110), a first DC/DC converter (120), a second DC/DC converter (130), and a three-phase AC unit (140).

The battery (110) may output a battery voltage and charge or discharge electrical energy. The battery voltage constitutes a base voltage of the battery module (10) and may provide an input voltage to the first DC/DC converter (120), the second DC/DC converter (130), and the three-phase AC unit (140).

Also, the battery (110) may have a lower battery voltage than the general high-voltage battery pack (11) described in FIG. 1. Therefore, the vehicle battery module (10) according to an embodiment of the present disclosure may adopt a power conversion device operable at low voltage, thereby reducing manufacturing costs.

Also, the battery module (10) according to an embodiment of the present disclosure may output voltages of various sizes and types depending on the series/parallel combination of the battery modules (10), and thus, the single-size battery module (10) may be used to be applied to various vehicle models and reduce manufacturing costs.

Furthermore, a three-phase battery system outputting a high-voltage AC system voltage may be may be configured by connecting three-phase AC module voltages of the battery modules (10) in series. Also, the battery modules (10) may be combined in parallel to form a battery system in which a large current flows.

Also, the first DC/DC converter (120) may convert the battery voltage into a first DC module voltage lower than the battery voltage and output the same.

The first DC module voltage may be set as a driving voltage for a low-voltage load in a vehicle. For example, the low-voltage load may be an electric load, such as various lamps, radio sets, and infotainment systems in an electric vehicle. The first DC module voltage may be set to a driving voltage of 12 V, 24 V, or 48 V, which is the driving voltage for the low-voltage load. However, the magnitude of the voltage mentioned herein are merely an example and may be set to voltages having various magnitudes depending on the design.

The first DC/DC converter may include input terminals (120a, 120b) and output terminals (120c, 120d). The first input terminals (120a, 120b) of the first DC/DC converter may be connected in parallel with the battery 110 to receive the battery voltage, and the output terminals (120c, 120d) of the first DC/DC converter may output a first DC module voltage. Hereinafter, the first DC/DC converter output terminals (120c, 120d) may also be referred to as DC module output terminals outputting the first DC module voltage.

Furthermore, the output terminals (120c, 120d) of the first DC/DC converter may be directly connected to a low-voltage load to provide the first DC module voltage.

In an embodiment, both ends (120c, 120d) of the output terminal of the first DC/DC converter may be connected to both ends of a low-voltage load to output a first DC module voltage.

The second DC/DC converter (130) may convert the battery voltage into a second DC module voltage and output the same. The second DC module voltage may be set to a value greater than the first DC module voltage output from the first DC/DC converter (120). The second DC module voltage may be less than or equal to the battery voltage or may be greater than the battery voltage.

Furthermore, the second DC module voltage output from the second DC/DC converter (130) may be connected in series with the second DC module voltage output from another battery module (10) to provide power to a high-voltage load. To reiterate, the second DC module voltage output from the second DC/DC converter (130) does not provide power to a high-voltage load as a single output, but may be connected in series with the second DC module voltage of another battery module (10) to provide power to the high-voltage load. Since the battery voltage included in the battery module (10) is configured as a low voltage, a plurality of battery modules (10) may be connected in series to provide high voltage to a high-voltage load, such as an air-conditioning system. To reiterate, the output terminal of the second DC/DC converter may be connected in series with the output terminal of the second DC/DC converter of another battery module to form a high voltage and provide power to the high-voltage load.

In addition, the second DC/DC converter (130) may include input terminals (130a, 130b) and output terminals (130c, 130d). The input terminals (130a, 130b) of the second DC/DC converter may be connected in parallel with the battery (110) to receive the battery voltage, and the output terminals (130c, 130d) of the second DC/DC converter may output the second DC module voltage. In this specification, the output terminals (130c, 130d) of the second DC/DC converter may also be referred to as the second DC module output terminals outputting the second DC module voltage.

Also, the output terminals (130c, 130d) of the second DC/DC converter may be connected in series with the output terminals of the second DC/DC converter included in other battery modules or may be connected to a high-voltage load. A specific connection structure with the other battery module (10) will be described below.

The three-phase AC unit (140) may include three inverters (141-1, 141-2, 141-3). Each of the three inverters may be connected in parallel with the battery (110) and receive the battery voltage. Furthermore, the three-phase AC unit (140) may include three transformers (142-1, 142-2, 142-3), each of which may transform the AC voltage output from the inverter into an AC module voltage corresponding to one phase of the three-phase AC module voltage and output the same.

In other words, the three-phase AC unit (140) may convert the battery voltage into a three-phase AC module voltage and output the same. The three-phase AC module voltage may include an A-phase AC module voltage, a B-phase AC module voltage, and a C-phase AC module voltage. The three-phase AC unit (140) may include an input terminal and an output terminal. The input terminal of the three-phase AC unit may be connected in parallel with the battery to receive the battery voltage, and the output terminal of the three-phase AC unit may output the three-phase AC module voltage.

Hereinafter, the output terminal of the three-phase AC unit may also be referred to as an output terminal of the three-phase AC module outputting the three-phase AC module voltage. The three-phase AC unit (140) may be configured to supply AC power to an AC load according to the three-phase AC module voltage. Also, the three-phase AC unit (140) may be connected in series with three-phase AC units included in other battery modules by phases to supply AC power to the AC load. For example, the AC load may be a load, such as a motor that uses the three-phase AC voltage as a driving voltage.

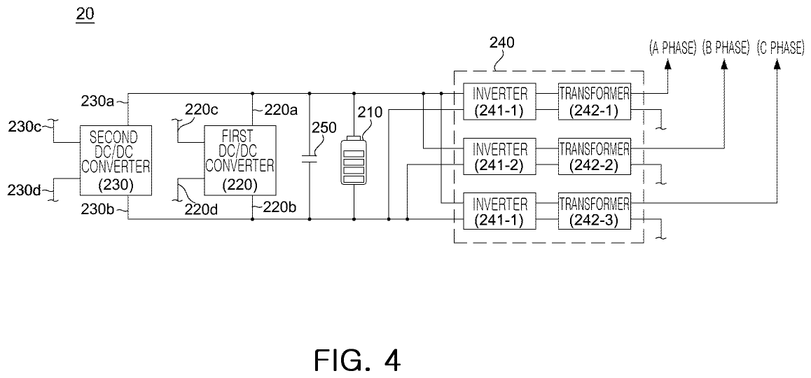

FIG. 4 illustrates a battery module according to an embodiment of the present disclosure.

Referring to FIG. 4, a battery module (20) according to an embodiment of the present disclosure may include a battery (210), a first DC/DC converter (220), a second DC/DC converter (230), a three-phase AC unit (240), and a common capacitor (250). The common capacitor (250) may be connected in parallel with the battery (210). The battery module (20) illustrated in FIG. 4 may include all the components of the battery module (10) illustrated in FIG. 3 and may further include the common capacitor (250).

According to the battery module (20) according to an embodiment of the present disclosure, a single common capacitor may be shared instead of separate capacitors for each inverter and converter device, thereby reducing volume. Furthermore, since low-voltage capacitors may be applicable, the production costs may be reduced.

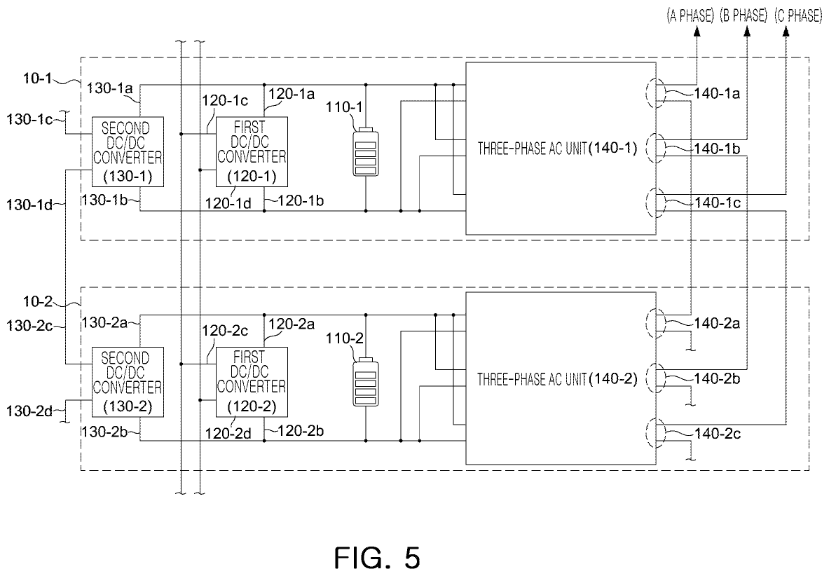

FIG. 5 is a diagram illustrating a connection structure between a plurality of battery modules according to an embodiment of the present disclosure.

Referring to FIG. 5, a first battery module (10-1) and a second battery module (10-2) may have the same configuration and may be configured with the same structure.

Furthermore, as described above with reference to FIG. 3, the first battery module (10-1) and the second battery module (10-2) may each include batteries (110-1, 110-2), first DC/DC converters (120-1, 120-2), second DC/DC converters (130-1, 130-2), and three-phase AC units (140-1, 140-2). Alternatively, as described above with reference to FIG. 4, the first battery module (10-1) and the second battery module (10-2) may further include a common capacitor.

In addition, a plurality of battery modules may be connected to form a three-phase battery system, and the connection relationship between the plurality of battery modules included in the three-phase battery system may be the same as the structure illustrated in FIG. 5.

More specifically, an A-phase AC module output terminal (140-1a) included in the three-phase AC unit (140-1) included in the first battery module (10-1) may be connected in series with an A-phase AC module output terminal (140-2a) included in the three-phase AC unit included in the second battery module (10-2). Furthermore, a B-phase AC module output terminal (140-1b) included in the three-phase AC unit included in the first battery module (10-1) may be connected in series with a B-phase AC module output terminal (140-2b) included in the three-phase AC unit included in the second battery module (10-2). Furthermore, a C-phase AC module output terminal (140-1c) included in the three-phase AC unit included in the first battery module (10-1) may be connected in series with a C-phase AC module output terminal (140-2c) included in the three-phase AC unit included in the second battery module (10-2).

When the AC module voltage is set to 100 V, two three-phase AC units (140-1, 140-2) connected in series may output an AC voltage of 200 V. The AC module voltage may refer to the maximum AC voltage, the root mean square (RMS), etc., and generally refers to the root mean square (RMS).

The output terminals (120-1c, 120-1d) of the first DC/DC converter included in the first battery module (10-1) and the output terminals (120-2c, 120-2d) of the first DC/DC converter included in the second battery module (10-2) may be connected in parallel. The other end (120-1c) of the output terminal of the first DC/DC converter included in the first battery module (10-1) and the other end (120-2c) of the output terminal of the first DC/DC converter included in the second battery module (10-2) may be connected in parallel to output the first DC module voltage. Furthermore, the output terminal of the first DC/DC converter, in which the other ends of the output terminals of the first DC/DC converters are connected in parallel, may output the first DC module voltage and may be connected to a low-voltage load using the first DC module voltage as a driving voltage to provide voltage.

The output terminals (130-1c, 130-1d) of the second DC/DC converter included in the first battery module (10-1) and the output terminals (130-2c, 130-2d) of the second DC/DC converter included in the second battery module (10-2) may be connected in series.

To summarize, in the first battery module (10-1) and the second battery module (10-2), the output terminals having the same phase of the three-phase AC unit may be connected in series, the output terminals of the first DC/DC converter may be connected in parallel, and the output terminals of the second DC/DC converter may be connected in series.

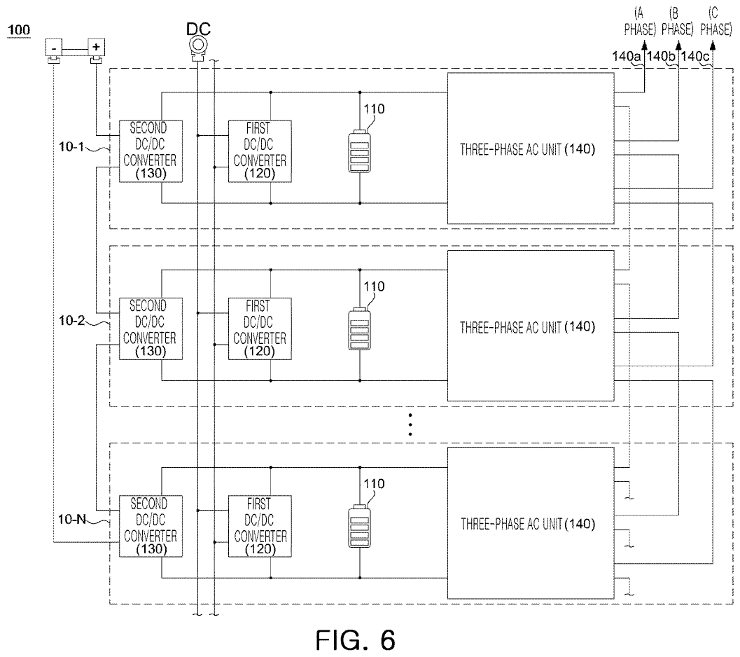

FIG. 6 illustrates a three-phase battery system according to an embodiment of the present disclosure.

Referring to FIG. 6, a three-phase battery system (100) according to an embodiment of the present disclosure may include a plurality of battery modules (10-1, 10-2, . . . , 10-N). Also, each of the plurality of battery modules (10-1, 10-2, . . . , 10-N) included in the three-phase battery system (100) may be the same as the battery modules (10, 20) illustrated in FIG. 3 or 4. Furthermore, the plurality of battery modules (10-1, 10-2, . . . , 10-N) included in the three-phase battery system (100) may have the connection structure between battery modules illustrated in FIG. 5.

According to an embodiment of the present disclosure, the three-phase battery system (100) may include a first DC system output terminal configured by connecting the first DC module output terminals included in each of the plurality of battery modules in parallel. For example, the first DC system output terminal may output a first DC system voltage, which may have the same magnitude as that of the first DC module voltage output from the output terminal of the first DC/DC converter.

Furthermore, the three-phase battery system (100) according to an embodiment of the present disclosure may include a second system output terminal configured by connecting the second DC module output terminals included in each of the plurality of battery modules in series. At this time, the second DC system output terminal may output a second DC system voltage, which may be configured as an integer (N) multiple of the voltage of the second DC module.

Furthermore, the three-phase battery system (100) according to an embodiment of the present disclosure may include three-phase AC system output terminals (130a, 130b, 130c) configured by connecting the output terminals of three-phase AC units included in each of a plurality of battery modules in series by phases. The three-phase AC system output terminal may output A phase, B phase, and C phase AC system voltages, and the AC system voltage may have a magnitude of an integer (N) multiple pf the AC module voltage output from the output terminal of the three-phase AC unit. Meanwhile, the three-phase AC system output terminal may provide AC power to an AC load.

To sum up, the three-phase battery system (100) may provide various output voltages, including a first DC system voltage, a second DC system voltage, and an AC system voltage, by connecting the individual components of the plurality of battery modules in series and/or in parallel.

Also, an electric vehicle may include AC loads, such as a low-voltage load (R1) operating at low voltage, a high-voltage load (R2) operating at high voltage, and a motor (M) operating at high-voltage three-phase AC voltage. Furthermore, the low-voltage load may use the first DC system voltage as a driving voltage, the high-voltage load may use the second DC system voltage as a driving voltage, and the AC load may use the AC system voltage as a driving voltage.

Also, the three-phase battery system (100) may further include a controller (not shown). The controller may individually control each battery module and may individually control the first DC/DC converter, the second DC/DC converter, the inverter, and the transformer included in each battery module. Therefore, according to an embodiment of the present disclosure, energy efficiency may be improved by performing balancing control for each power conversion device and each battery module.

Furthermore, if a problem occurs in some of the N battery modules, the controller may control the shutdown of only a defective battery module, thereby ensuring the reliability of the entire system.

Furthermore, since the controller may individually control each battery module, even if deterioration occurs differently in each battery module, the deterioration performance of each battery module may be actively controlled.

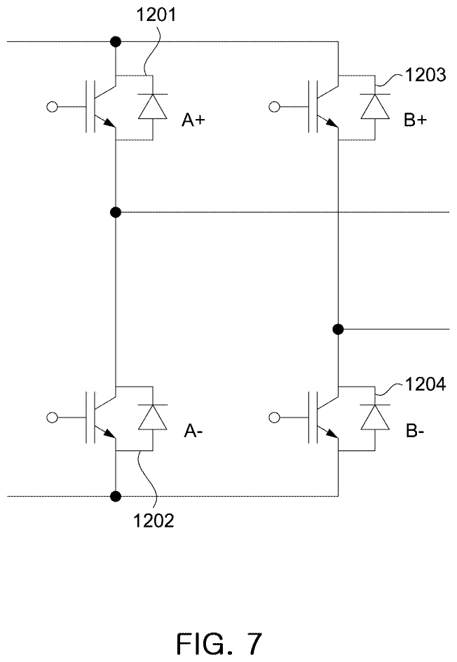

FIG. 7 is a diagram illustrating a structure of an inverter according to an embodiment of the present disclosure.

Referring to FIG. 7, the inverter may include a plurality of Si-MOSFET (Metal Oxide Semiconductor Field Effect Transistor) devices (1201, 1202, 1203, 1204) and may be configured as an H-bridge single-phase inverter structure.

Conventional electric vehicle systems primarily use SiC power semiconductors. These SiC power semiconductors offer high efficiency and fast switching speeds, but are expensive.

Furthermore, conventional electric vehicle systems sometimes use insulated gate bipolar transistors (IGBTs) at low voltage. While IGBTs are relatively inexpensive, they may have slow switching speeds.

Meanwhile, Si-MOSFET devices offer fast switching speeds and are relatively inexpensive, but their performance degrades at high voltage, and thus, Si-MOSFET devices are difficult to apply in conventional high-voltage electric vehicle systems.

Since the battery module according to an embodiment of the present disclosure operates at low voltage, Si-MOSFET devices may be used in inverters. Therefore, the inverter included in the battery module according to an embodiment of the present disclosure may use a plurality of Si-MOSFET devices, thereby reducing production costs, while achieving fast switching speeds. Accordingly, fuel efficiency may be improved and a vehicle driving range may be increased. Furthermore, as the driving range increases, battery capacity may be reduced, thereby reducing costs.

Furthermore, the inverter according to an embodiment of the present disclosure is configured as an H-bridge single-phase inverter structure, thereby maintaining stability even at high currents.

Furthermore, while FIG. 7 illustrates an H-bridge circuit using four Si MOSFETs as an example, it is also possible to configure an H-bridge circuit by connecting a plurality of Si MOSFETs in parallel with enable high-current switching.

As described above, the present disclosure, as a technology for replacing conventional electric vehicle driving systems that operate at high voltage by connecting standardized battery modules operating at low voltage in series or in parallel, may provide various outputs by connecting battery modules in series or in parallel as needed.

While the present disclosure has been particularly shown and described with reference to exemplary embodiments thereof, a person skilled in the art will understand that the invention is not limited to the disclosed exemplary embodiments but may be variously modified within the scope of the present disclosure. Therefore, the scope of the present disclosure should not be limited to the above-described embodiments but should be determined by all changes or modifications derived from the scope of the appended claims and equivalents of the following claims.

### DESCRIPTION OF REFERENCE CHARACTERS

1: CONVENTIONAL ELECTRIC VEHICLE DRIVING SYSTEM 11: HIGH-VOLTAGE BATTERY PACK
12: POWER CONVERSION DEVICE
10, 20: BATTERY MODULE 110: BATTERY
120: DC/DC CONVERTER 130: DC/DC CONVERTER
140: THREE-PHASE AC UNIT
141: INVERTER 142: MULTI-WINDING TRANSFORMER
100: THREE-PHASE BATTERY MODULE SYSTEM

1. A vehicle battery module comprising:
a battery outputting a battery voltage;
a first DC/DC converter converting the battery voltage into a first direct current (DC) module voltage lower than the battery voltage and outputs the first DC module voltage; and
a three-phase alternating current (AC) unit converting the battery voltage into a three-phase AC module voltage and outputting the three-phase AC module voltage,
wherein the three-phase AC unit includes an inverter converting the battery voltage into an AC voltage and a transformer converting an output of the inverter into an AC module voltage corresponding to one phase of the three-phase AC module voltage.

2. The vehicle battery module of claim 1, further comprising a second DC/DC converter converting the battery voltage into a second DC module voltage higher than the first DC module voltage and outputting the second DC module voltage.

3. The vehicle battery module of claim 1, further comprising a capacitor connected in parallel with the battery.

4. The vehicle battery module of claim 1, wherein the battery is configured to be connected in parallel with an input terminal of the first DC/DC converter and an input terminal of the inverter.

5. The vehicle battery module of claim 1, wherein an output terminal of the first DC/DC converter is configured to be connected in parallel with a low-voltage load using the first DC module voltage as a driving voltage.

6. The vehicle battery module of claim 2, wherein the second DC/DC converter is configured to supply DC power to a high-voltage load using an integer multiple of the second DC module voltage as a driving voltage.

7. The vehicle battery module of claim 1, wherein the three-phase AC unit is configured to supply AC power to an AC load using a driving voltage that is an integer multiple of the three-phase AC module voltage.

8. A three-phase vehicle battery system comprising:
a plurality of vehicle battery modules including a first direct current (DC) module output terminal outputting a first DC module voltage that is lower than an internal battery voltage from the internal battery voltage and a three-phase alternating current (AC) module output terminal outputting a three-phase AC module voltage having the same phase difference;
a first DC system output terminal configured as the first DC module output terminals respectively included in the plurality of vehicle battery modules are connected in parallel; and
a three-phase AC system output terminal configured as the three-phase AC module output terminals respectively included in the plurality of vehicle battery modules are connected in series by phases.

9. The three-phase vehicle battery system of claim 8, wherein
each of the plurality of vehicle battery modules includes:
a battery outputting a battery voltage;
a first DC/DC converter converting the battery voltage into a first DC module voltage and outputs the first DC module voltage; and
a three-phase AC unit converting the battery voltage into a three-phase AC module voltage and outputting the three-phase AC module voltage,
wherein the three-phase AC unit includes an inverter converting the battery voltage into an AC voltage and a transformer converting an output of the inverter into an AC module voltage corresponding to one phase of the three-phase AC module voltage.

10. The three-phase vehicle battery system of claim 8, wherein
the plurality of vehicle battery modules each further include a second DC module output terminal outputting a second DC module voltage higher than the first DC module voltage, and
wherein the three-phase vehicle battery system further includes a second DC system output terminal configured as the second DC module output terminals respectively included in the plurality of vehicle battery modules are connected in series.

11. The three-phase vehicle battery system of claim 9, wherein the battery is configured to be connected in parallel with an input terminal of the first DC/DC converter and an input terminal of the inverter.

12. The three-phase vehicle battery system of claim 8, wherein the first DC system output terminal is configured to be connected in parallel with a low-voltage load using the first DC module voltage as a driving voltage.

13. The three-phase vehicle battery system of claim 10, wherein the second DC system output terminal is configured to be connected to a high-voltage load using an integer multiple of the second DC module voltage as a driving voltage.

14. The three-phase vehicle battery system of claim 8, wherein the three-phase AC system output terminal is configured to be connected to an AC load using a driving voltage that is an integer multiple of a magnitude of the three-phase AC module voltage.

15. The three-phase vehicle battery system of claim 8, wherein the number of the plurality of vehicle battery modules is set based on a ratio of a voltage magnitude of the three-phase AC system output terminal to a magnitude of the three-phase AC module voltage.
